(19) United States
(12) Patent Application Publication
(10) Pub. No.: US 2020/0249138 A1
(43) Pub. Date: Aug. 6, 2020

(54) Device and Method for Automatic Workpiece Inspection

(71) Applicant: Imprintec GmbH, Bochum (DE)

(72) Inventors: Benjamin Schmaling, Breckerfeld (DE); Ralf Anderseck, Nordkirchen (DE); Karl-Heinz Lindner, Hattingen (DE); Peter Zok, Hattingen (DE)

(21) Appl. No.: 16/756,223

(22) PCT Filed: Oct. 16, 2018
(86) PCT No.: PCT/EP2018/078289

§ 371 Date: Apr. 16, 2020

(30) Foreign Application Priority Data
Oct. 16, 2017 (DE) 10 2017 124 051.9
Mar. 22, 2018 (DE) 10 2018 106 913.8

(51) Int. Cl. G01N 3/42; G01N 3/06

(52) U.S. Cl. CPC G01N 3/42; G01N 2203/008; G01N 3/068

(57) ABSTRACT

The invention relates to a measuring device (10) for determining at least one mechanical property of a workpiece sample (100), which comprises at least one image capturing unit (12) for optically determining a workpiece geometry of the workpiece sample (100), and at least one mechanical inspection head (13) for making an indentation (101) in the workpiece sample (100). According to the invention, at least the image capturing unit (12) and the mechanical inspection head (13) form a structural unit (B) together.

The invention relates to a measuring device for determining mechanical properties of a workpiece probe according to the independent device claim and a method for determining mechanical properties of a workpiece probe according to the independent method claim. Furthermore, the invention relates to a computer program product for a measuring device for determining mechanical properties of a workpiece probe.

In principle, measuring devices are known for determining the mechanical properties of a workpiece probe. A distinction can be made between non-destructive and destructive materials testing. State-of-the-art measuring devices, however, have complex and cost-intensive measuring equipment, whereby manual intervention by an operator is always necessary to ensure that the material test provides correspondingly qualitative measurement results. In many cases, several structurally separate measuring devices are also necessary in order to be able to perform the desired measuring methods. A so-called online measurement or inline measurement during ongoing production is not possible, especially with destructive material testing. However, non-destructive or low-destructive materials testing also requires short testing times during ongoing production so that the ongoing production method is not interrupted or delayed.

It is the object of the invention to remedy, at least in part, these disadvantages known from the prior art. In particular, it is the object of the present invention to enable a material test, in particular a non-destructive and/or low-destructive material test, preferably in the running production method, with only one measuring device, whereby preferably the corresponding measuring method can be performed essentially automatically.

The above object is solved by a measuring device with the characteristics of the independent device claim, a method with the characteristics of the independent method claim and a computer program product with the characteristics of the independent software claim. Further features and details of the invention result from the dependent claims, the description and the drawings. Features and details which have been described in connection with the device according to the invention are of course also valid in connection with the method and/or the computer program product according to the invention and vice versa, so that with regard to disclosure, the individual aspects of the invention are or can always be mutually referred to.

The measures and technical features listed in the dependent claims allow for advantageous developments and improvements of the subject matter of the invention specified in the independent claims.

In accordance with the invention, the measuring device for determining (in particular non-destructive and/or low-destructive) mechanical properties of a workpiece probe, which may be fixed in a workpiece receptacle of the measuring device for testing, has at least one image acquisition unit for optically determining a workpiece geometry of the workpiece probe. In addition, the measuring device according to the invention has at least one mechanical probe for generating a particularly mechanical impression in the workpiece probe. Furthermore, at least the image acquisition unit and the mechanical probe together form a structural unit.

The term “workpiece probe” covers all samples to be examined, in particular material samples and material specimens which are examined, among other things, with regard to their material properties. The mechanical properties of the workpiece probe are of particular interest here, as this may be processed further as a semi-finished product. The term “mechanical impression” refers to a generated impression, preferably in the surface of the workpiece probe, which is generated by the mechanical probe in the workpiece probe, comparable to a grain size generated by a grain. The workpiece probes may contain material that has anisotropic properties and is therefore also referred to as “anisotropic material” and/or “anisotropic workpiece probe” in the following.

The structural combination of the image acquisition unit and the mechanical probe into one structural unit offers the advantage that a fully automatic measurement on the workpiece probe can be realized, preferably without moving the workpiece probe itself and/or measuring device. In particular, this automatic measurement requires no manual intervention by the operating personnel during the execution of the corresponding measuring and testing method.

Preferably, this measuring device can also be moved to the workpiece probe (preferably once only) to perform the method, so that the workpiece probe is not moved to the measuring device, but vice versa, the corresponding measuring device is moved to the workpiece probe. Especially in the case of rolled, extruded, cast and/or drawn workpiece probes, in particular those generated in a continuous manufacturing process, e.g. by rolling, drawing or the like, the previously described feeding of the measuring device to the (in particular continuous) workpiece probe is of great advantage. It is also conceivable that a structural separation between the measuring device and the workpiece receptacle, which is also necessary, could be achieved, thus extending the possible applications of the measuring device according to the invention.

Thus, for example, it is possible to integrate the measuring device according to the invention into the production and/or processing method of the workpiece probes, in which the measuring device transmits the respective specific mechanical properties of a workpiece probe to a spaced-apart electronic unit (in particular configured as a server and/or cloud) preferably by radio and/or wire and/or network, whereby a feedback is formed in the control loop of the production and/or processing method of the workpiece probes. This allows an optimization of the production and/or processing of the workpiece probes at a very early stage, so that less waste can be generated and the quality can be improved.

A workpiece probe in the sense of the invention can be understood as one or more components, surface layers and/or material samples. The mechanical properties of the workpiece probes can be hardening behavior, damage parameters, elongation at break, tensile and/or compressive strength, ductility, deformability, toughness, beginning of flow, yield strengths, parameters describing creep behavior, parameters describing material fatigue, yield strength and/or material hardening. The invention can also be used to determine other material properties of the workpiece probes, such as rolling or stretching direction. Likewise, anisotropic materials can also be investigated by invention or their material properties can be determined.

Preferably, a workpiece receptacle is also provided for fixing and testing the workpiece probe, which can be mechanically connected or fixed, in particular via a test frame of the unit consisting of the image acquisition unit and the mechanical probe. Since the mechanical probe exerts a test force on the workpiece probe, it is advantageous that the workpiece probe is rigidly fixed, especially in the workpiece receptacle. If the probe is fixed in the receptacle, the correction effort required to obtain accurate measurement results is increased.

In this context, the measuring device according to the invention can be used to perform a workpiece/material test, in particular a non-destructive and/or low-destructive test (in particular fully automatic, i.e. without manual intervention), which can lead in particular to the determination of local material properties. In contrast to conventional tensile and hardness tests, a mechanical impression, which is, however, low-destructive or non-destructive for the workpiece probe, is made in the workpiece probe during the measurement according to the invention to determine mechanical properties of a workpiece probe, whereby local material properties/parameters are determined, preferably by comparing an impression topography measured (in particular exclusively optically) with a computer-based simulation of a theoretical impression topography using a material model, an optimization algorithm and/or a method of artificial intelligence, machine learning, etc. etc., can be determined.

For this purpose, the workpiece probe can be fixed in the workpiece receptacle, preferably via a chuck, in particular a quick-action chuck, or a fixing unit of the measuring device and this can be optically detected by an image acquisition unit in such a way that the workpiece geometry of the workpiece probe can be determined by the image acquisition unit. The workpiece can also be picked up without clamping the workpiece probe, depending on the shape of the probe, e.g. in the case of plane-parallel probes, and where the impression is to be made. However, the workpiece fixture should form an unyielding base for the workpiece probe to counteract the test force of the mechanical probe. In the sense of the invention, the workpiece geometry can be understood to mean in particular the surface geometry and/or the geometric dimensions. According to the invention, it is conceivable here that the image acquisition unit optically acquires the workpiece probe one-dimensionally in conjunction with a grid, two-dimensionally and/or three-dimensionally. The at least one mechanical probe of the measuring device can (after optical detection) make a mechanical impression on the workpiece probe by means of an impression method with a test force. Ideally, after each mechanical impression made, an optical and/or tactile detecting of the respective impression topography also takes place in order to improve the accuracy of the entire method.

The probe, the workpiece receptacle and/or the image acquisition unit can be constructed so as to be movable relative to one another, whereby according to the invention at least one drive unit is provided for at least partial positioning of the workpiece receptacle, the image acquisition unit and/or the probe relative to one another. This means that the workpiece probe does not have to be reclamped or reattached workpiece probe during a measurement. The drive unit can be driven mechanically, electrically, electromechanically, hydraulically and/or pneumatically. The drive unit can also be configured “passively” as a dead weight and/or spring drive and/or force/energy accumulator, so that no active drive is required for the relative movement of the probe to the workpiece probe.

It is also conceivable that only one of the three components: workpiece receptacle, image acquisition unit and probe or all components are configured to move relative to each other. Preferably, the mechanical probe of the unit in accordance with the invention is configured so that it can move relative to the image acquisition unit. It is also conceivable that more than one drive unit is provided. In this case, at least one drive unit can be provided for the adjustment or movement of the mechanical probe unit and/or the image acquisition unit. A drive unit can also position at least one component, workpiece receptacle, image acquisition unit and/or probe, or one drive unit can drive more than one component or all components, the workpiece receptacle, image acquisition unit and/or the probe and thus at least partially position them. Preferably the at least one drive unit serves at least for partial positioning of the workpiece receptacle with a workpiece probe fixed therein and the at least one probe relative to one another, so that an impression, in particular a mechanical impression, can be generated in the workpiece probe. This method can also be described as hardness testing or impression method, in particular nanoindentation method. Within the scope of the invention, the workpiece probe may in particular exhibit an isotropic and/or anisotropic material, in particular sintered materials and/or hardened materials.

In addition, it is conceivable that the probe, the workpiece receptacle and/or the image acquisition unit are arranged interchangeably on the measuring device. The measuring device according to the invention thus enables a (in particular complete) automatable materials testing, which can be integrated in particular into existing production systems and/or methods.

Since the drive unit may consist of a cylinder, motor or the like, it is advisable that an adjustment element is provided between the drive unit and the component to be moved (meaning at least the image acquisition unit, the mechanical probe and/or the workpiece receptacle). This adjusting element may comprise a linkage, a gear, a line system, wire or rope. Preferably backlash-free adjustment elements are used to increase the precision of the measuring device according to the invention.

It is also conceivable that the entire unit can be moved by the drive unit and the aforementioned adjustment element. Furthermore, it is possible that several drive units and several adjustment elements are provided in order to enable a variable adjustability of the individual components to each other. In this way, the possible applications of the measuring device according to the invention can be significantly increased.

In order to obtain the most stable measuring device possible, it is advantageous to keep the degree of freedom for adjusting the image acquisition unit and/or the mechanical probe, especially in relation to each other, as low as possible. For this purpose, the unit may be provided with at least one deflection unit, whereby a beam path of the image acquisition unit can be deflected. By these measures it is even conceivable that the image acquisition unit is rigidly arranged in relation to the mechanical probe in the assembly unit, whereby only the probe tip is configured to be movable. This eliminates the need for adjustment between the mechanical probe and the image acquisition unit during a measurement method.

The deflection unit preferably has at least one mirror, preferably at least two mirrors, to deflect the beam path. It is also conceivable that at least one mirror can be moved relative to the unit. Preferably, a first mirror can be fixed and a second mirror is movable, whereby the beam path can be deflected twice in total in order to enable optical determination of a material geometry for the image acquisition unit.

Furthermore, the measuring device according to the invention enables an essentially non-destructive material testing, whereby the intervention of an operator for the determination of mechanical properties of the workpiece probe can at least be reduced or even completely avoided, while at the same time the speed for the execution of the method or the testing can be increased many times over by automation. In this way, the results obtained on the mechanical properties of the workpiece probe can be significantly improved, since personal operating errors can be at least partially or even completely avoided. The reproducibility of the measuring method can also be significantly improved. The optical determination of the workpiece geometry, the mechanical impression in the workpiece probe as well as the optical detecting of the mechanical impression can be made possible (automatically) by at least partial or complete positioning of the components to each other. Thus, an automatic testing of one or more workpiece probes can be performed by the device according to the invention, preferably fully automatically. This allows the measuring method to be performed particularly quickly and accurately, especially in an online production and/or processing method of the workpiece probe, so that the reproducibility of the measuring results is excellent.

Within the scope of the invention, at least the image acquisition unit, the probe, the drive unit and the workpiece receptacle can be arranged on a test frame, whereby in particular a movable test table can be provided on which the workpiece receptacle can be arranged. A compact construction of the measuring device can be achieved by a common test frame on which at least the image acquisition unit, the probe, the drive unit and the workpiece receptacle can be arranged. On the test frame, the workpiece receptacle, the image acquisition unit and/or the probe can be positioned at least partly relative to one another, so that in particular a relative movement between the workpiece receptacle, the image acquisition unit and/or the probe can be performed. The positioning or a movement relative to one another can be configured horizontally (in the y-direction) and/or vertically (in the x-direction) and/or rotationally, wherein in particular a movable test table is provided on which the workpiece receptacle can be arranged and which is configured in such a way that at least partial positioning relative to one another can be performed. The test table can be configured in such a way that at least one workpiece probe or a plurality of workpiece probes or workpieces can be arranged on the workpiece receptacle of the movable test table and the test table can be moved horizontally, vertically and/or rotationally. According to the invention, the test frame can have a U-shape, whereby the test table and/or the workpiece receptacle can be arranged on one limb and the image acquisition unit and/or the probe on the other limb. The at least one drive unit may also be arranged on one of the legs I of the test frame. Thus, a compact structure of the measuring device is generated by the test frame.

It is also conceivable that the probe has a probe tip, whereby the probe tip has at least one mineral or hard metal. Other materials for the probe tip are also conceivable, depending on the workpiece probe. The probe tip itself can be interchangeable, preferably via a chuck, especially a quick-action chuck. In particular, the probe tip can have a defined probe tip geometry. According to the invention, a mineral can be a diamond or a ruby. A hard metal can be in the form of a sintered carbide tungsten carbide, which enables high hardness and wear resistance to be achieved. Preferably, the carbide can at least contain tungsten carbide and/or cobalt. In addition, it is conceivable that the probe tip may have titanium carbides, tantalum carbides, chromium carbides and/or varnadium carbides, especially in a metallic material. The high hardness and wear resistance that can be achieved in this way can thus enable comparable, and in particular constant, mechanical impressions in a workpiece probe over a long period of time. Furthermore, the wear of such hard metals and minerals is low. The probe tip geometry can be spherical, conical, sphero-conical or spherical. Preferably, the probe tip is configured geometrically in such a way that a material expansion in the area of the mechanical impression in the workpiece probe can be achieved. It is particularly preferred if the probe tip geometry is rotationally symmetrical, so that an optical detection of the mechanical impression in an isotropic workpiece probe (with isotropic material) has a rotationally symmetrical course. Accordingly, averaging along the mechanical impression can be performed, for example, in degree angle steps, preferably every 1° to 5°. In the case of an anisotropic workpiece probe, there is usually no rotationally symmetrical course, but rather a cloverleaf-shaped course, for example.

Advantageously, a depth gauge (as well as a force gauge, if necessary) can be provided for the probe, among other things, whereby at least one impression depth (also called penetration depth) of the probe, in particular the probe tip, can be measured in the workpiece probe. The measuring method is preferably performed with predefined test conditions, e.g. predefined force and/or impression depth. Due to the known probe tip geometry and the measured data for penetration force and penetration path, the contact area and subsequently the previously mentioned material parameters/properties can be averaged. A depth gauge in accordance with the invention can be a plate capacitor, in particular a propellant plate capacitor, which is mounted on an atomic force microscope, for example, and when a force is applied to make a mechanical impression in the workpiece probe, a change in capacitance in the plate capacitor can be measured. On the one hand, this allows the necessary force and the corresponding penetration depth to be measured, whereby the workpiece parameters/properties can also be concluded.

According to the invention, the depth of impression or penetration of the probe, in particular of the probe tip, can be between approximately 1 μm and approximately 3,000 μm, preferably between approximately 10 μm and approximately 500 μm, particularly preferably between approximately 50 μm and approximately 250 μm. The low impression depth allows an essentially non-destructive material testing of the workpiece probe and at the same time metals, alloys and certain plastics can be measured by the measuring devices. Accordingly, the workpiece probes or components remain almost unharmed during the measuring method, as invented, compared to e.g. known tensile tests, which usually destroy the sample.

A light source may be provided within the scope of the invention, in particular the light source may be integrated in the imaging unit. According to the invention, the light source serves for (optimal) illumination of the workpiece probes or the mechanical impression in the workpiece probe. Thus, the light source in the image acquisition unit can be configured as part of the optical sensor and thus also belong to the measuring method (e.g. like interferometer). The light source can illuminate the surface geometry of the workpiece probe and the impression geometry of the mechanical impression in such a way that the workpiece geometry and the impression geometry can be optically detected via the image acquisition unit. According to the invention, the light source can be regulated in such a way that the light intensity can be adapted to the existing light conditions, for example, so that reflections can be essentially prevented. The light source can, for example, be an optical sensor with at least one (integrated) infrared, LED and/or OLED light source. Preferably, the light source generates at least one light spot or linear light strip that can be controlled (light spot or light strip). Thus, the light can be sent to the defined points of the mechanical impression of the workpiece probe, whereby an optical measurement can be significantly improved. It is also conceivable that the existing light source illuminates the entire workpiece probe over a large area and in particular homogeneously.

The image acquisition unit can be configured as a confocal microscope or a chromatic white light sensor (a white light interferometer is preferred). A stereo lens is also conceivable in order to be able to detect the three-dimensional shape of the mechanical impression of the workpiece probe with particular optical precision. Additionally or optionally, various sensors (e.g. for laser triangulation, laser scanning, or for confocal microscope, profilometer, atomic force microscope, or as confocal sensor, focus variation sensor), especially based on focus variation, as well as white light sensors (point sensor) for measurement data acquisition (with or without additional light source) can be provided. The measured data of the mechanical impression of the workpiece probe are stored as a digital (generated) impression topography in a control unit and/or an electronic unit in a memory, e.g. as 3D geometry, or point cloud, or xyz triple, or data matrix, in order to be able to compare these, if necessary, subsequently with the computer-based simulation of a theoretical impression topography using a material model.

The mechanical properties of the workpiece probe, such as hardening behavior, damage parameters, elongation at break, tensile strength, ductility, deformability, toughness, flow start, yield strength, parameters describing creep behavior, parameters describing material fatigue, yield strength and/or hardening of the materials, can then be determined (especially indirectly).

It is further conceivable within the scope of the invention that a movable tool revolver is provided on which at least the probe and the image acquisition unit can be arranged. The tool revolver can be arranged to be rotationally and/or translationally movable, in particular on a limb of the test frame. Accordingly, the probe and/or the image acquisition unit can be positioned rotationally and/or translationally over the tool revolver. Furthermore, it is conceivable that the tool revolver has at least one aperture with an opening for the probe and/or the image acquisition unit. It is further conceivable that at least one light source in accordance with the invention can be arranged on the tool revolver. The tool revolver enables a compact configuration of the measuring device, whereby a movement of the tool revolver, in particular a rotational movement of the tool revolver, enables a change between the components, at least between the probe and the image acquisition unit during a measuring method. This results in an automatable test method in a compact installation space, whereby the measuring device can be integrated more easily into production systems and/or production methods. Accordingly, it is conceivable that a probe with a probe tip in particular is arranged at at least one opening and/or an aperture of the tool revolver and the image acquisition unit is arranged at a further opening. In addition, it may be provided that a light source in accordance with the invention can be arranged on a further aperture, the image acquisition unit, the probe and/or the light source being releasable and/or closable via the aperture.

Furthermore, it is conceivable within the scope of the invention that the measuring device can be arranged and/or moved on a support arm, in particular a robot arm. Thus, the measuring device can—as already mentioned before—be brought to the workpiece probe in order to perform the measuring method there. In this measuring device, the unit can be connected to the workpiece receptacle via the test frame. A solid base can also serve as a workpiece receptacle on which the workpiece probe can be placed, especially without play. It is also conceivable that the unit is configured separately and thus structurally separate from the workpiece fixture. At least one fixing unit can be provided to securely attach the measuring device to the workpiece probe, preferably during a measuring method. This is intended to increase the stability of a measuring device arranged on a support frame.

The measuring device according to the invention is suitable for checking and measuring metal workpiece probes. The workpiece probe may contain, preferably aluminum, magnesium, lead, iron, stainless steel, gold, molybdenum, nickel, copper, silver, vanadium, tungsten, zinc, tin, titanium and/or an alloy such as brass. Especially in the case of workpiece probes which contain magnesium, which means a magnesium content of >10% of the total material is meant, is of particular economic advantage if the mechanical properties can already be determined non-destructively during the manufacturing method. In addition, within the scope of quality assurance, the determined mechanical properties of each manufactured and further processed workpiece can be determined and detected. In this way a complete quality assurance can be achieved.

Especially in the case of workpiece probes which are rolled, extruded, cast or drawn, these mechanical properties can be determined by the invention during the manufacturing method. In particular, direction-dependent (mechanical) properties of the material can be determined, such as in the case of anisotropic workpiece probes.

According to the invention, it is possible that at least one control unit is provided for controlling and/or regulating and/or evaluating data of the image acquisition unit and the drive unit, in particular that the measuring device has at least one interface for transmitting data of the image acquisition unit and the drive unit to a spaced-apart electronic unit. The control unit in accordance with the invention serves for the control and/or regulation and/or evaluation of data of the measuring device, wherein parameters for determining the material properties or material parameters can be set in particular via the control unit. Accordingly, at least the penetration depth, the penetration force and/or the number of mechanical impressions to be made on the workpiece probe can be controlled and/or regulated via the control unit. In addition, data of the measurement, e.g. of the image acquisition unit, the drive unit, in particular the probe, the probe tip and/or the depth gauge and/or force gauge can be obtained via the control unit. For this purpose, the control unit can be equipped with a memory for data storage. The control unit can also have at least one computing unit (microprocessor) in order to be able to calculate the computer-based simulation of a theoretical impression topography using a material model and, if necessary, compare it with the generated impression topography (from the memory) or obtain it from a database or map it using a neural network.

It is further conceivable that the measuring device has at least one (wired or wireless) interface for transmitting data from the image acquisition unit and the drive unit to a spaced-apart electronic unit, in particular a server, a cloud, a computer, a tablet, a smartphone and/or a smartwatch. The interface can be configured as a plug, cable and/or wireless transmission method. Accordingly, an interface can be arranged on the measuring device, in particular on the test frame of the measuring device, so that a transmission, in particular the receiving and/or sending of the data between the measuring device and a spaced-apart electronics unit can be performed. Within the scope of the invention it is conceivable that the interface, in particular data interface, is configured as Bluetooth, NFC, Wireless-Lan and/or GSM interface. The transmission of data from the image acquisition unit, the drive unit, the probe, in particular the depth gauge, can be configured bidirectionally so that data can be both received and transmitted. The data transmission can also be encrypted to prevent interference and manipulation. In accordance with the options mentioned above, it is conceivable that data, especially data for defined test conditions, e.g. test force and/or penetration depth, can be transmitted from a spaced electronic unit. In addition, data of the image acquisition unit, e.g. the workpiece geometry and in particular the impression geometry or impression topography, can be transmitted to the spaced electronic unit in order to be able to calculate it there with the computer-based simulation of a theoretical impression topography using a material model and, if necessary, to be able to compare it with the generated impression topography or to obtain it from a database or to map it by means of a neural network. By using a spaced electronic unit, a significant time saving can be achieved when performing the method, which is of decisive importance especially for online measurements, as otherwise the manufacturing method must be interrupted.

According to another aspect of the invention, a method for determining mechanical properties of a workpiece probe is claimed according to the independent method claim. The method claimed in the invention brings the same advantages as those described in detail with respect to the device claimed in the invention. The method comprises at least one or all of the following steps:
a) Optical and/or tactile detection of a workpiece geometry of the workpiece probe,
b) Generation of a particularly mechanical impression by penetration of a probe, in particular a probe tip, into the workpiece probe with defined test conditions,
c) Optical and/or tactile detection of an impression topography of the generated impression in the workpiece probe,
d) In particular computer-based simulation of a theoretical impression topography (of the impression) using a material model, in particular an elastoplastic model, preferably for anisotropic materials,
e) Comparison of the simulated and the mechanically generated impression topography,
f) Determination of the mechanical properties of the workpiece probe as a function of steps a) to e).

Step a) is not necessary if the geometry of the workpiece probe is already known on the basis of previous information and is not subject to any fluctuations. In order to improve the accuracy of the method, it is recommended that step a) also be performed. Also, at least steps a) to c) can be performed automatically, preferably all steps a) to f) are performed automatically, thus avoiding personal operating errors. In particular, some (or all) of the method steps can be performed simultaneously or consecutively. Preferably steps d) and e) are repeated and/or iterative until hardly any differences can be detected when comparing in step e). Subsequently, step f) can be performed, which thus determines particularly exact data (for the mechanical properties of the workpiece probe). Step f) can also take place after step e) each time.

Thus, steps d), e) and f) can actually form a common (comparison) step in the iterative method.

1. simulations are performed repeatedly (or the simulated geometry is taken from a database) and compared with the real geometry, whereby an error square can be obtained

2. this error square is reduced by increasingly “fitting” simulations

3. If the error square is very small, the method can be aborted.

The result from step f) is then output.

The method according to the invention can essentially show three impressions (I. to III.) with different properties. This is at least one mechanically generated impression (I.) according to method step b), which can be generated by penetration of a probe, in particular a probe tip, into the workpiece probe with defined test conditions. Furthermore, an impression (II.) can be defined by the fact that the mechanically generated impression can be detected optically and/or tactilely, in particular by an image acquisition unit. In this case, the optical and/or tactile detecting is used to generate an impression topography of the mechanically generated impression in the workpiece probe. A further third impression (III.) is a simulated impression according to method step d), whereby a simulation, in particular a computer-based simulation, of a theoretical impression topography of the mechanically producible impression in the workpiece probe can be performed. In this case, the simulated theoretical impression topography can be performed using one (or more) (theoretical) material model, an elastoplastic model, preferably for anisotropic materials, it being possible to determine the material model in particular on the basis of the defined test condition data and using an algorithm and/or a heuristic. The material model can be elastoplastic, elastoviscoplastic or plastic. In step e), the simulated, in particular computer-based and thus theoretical impression or impression topography is and the mechanically generated impression topography, which is determined by an image acquisition unit, in particular by optical and/or tactile acquisition, are compared. On the basis of the at least three impression models, the mechanically generated impression by the probe, in particular the probe tip, the optically and/or tactilely detected and mechanically generated impression and the simulated impression topography, in particular the generated and detected as well as simulated impression topography, a determination of the mechanical properties of the workpiece probe can be performed in step f). During the optical and/or tactile detecting of an impression topography of the generated impression in the workpiece probe, a 3D elevation image of the mechanically generated impression in the workpiece probe is preferably determined. In the computer-based simulation of a theoretical impression topography, a 3D elevation image of the theoretical impression is also simulated. The two 3D elevation images are then compared with each other, whereby the mechanical properties, in particular hardening behavior, damage parameters, elongation at break, tensile strength, ductility, deformability, toughness, start of flow, strain limits, parameters describing creep behavior, parameters describing material fatigue, or similar parameters can be determined. When generating the mechanical impression and thus generating an impression topography in the workpiece probe, an impression is preferably generated in the workpiece probe using predefined test conditions/parameters such as a test force and/or test depth.

In the case of isotropic materials of an “isotropic” workpiece probe, a simplified material model can be used, since there is usually a rotationally symmetric impression topography due to the impression generated in the workpiece probe. In contrast, for all anisotropic materials, modified material models have to be included in the computer simulation. Preferably, an elastoplastic material model is used, which has additional model parameters so that direction-dependent properties of the workpiece probe can be determined.

Ideally, at least one FEM (Finite Element Simulation) of a theoretical impression topography using the material model is performed in step d). By using the FEM simulation, the mechanical properties of the workpiece probe can be determined particularly accurately using the simulation. In addition, mathematical methods optimized for FEM simulation have been developed in order to run the computer-based simulation in the shortest possible time steps.

It is preferably intended that in a step c2) the detected material geometry of the workpiece probe from step a) is taken into account in the actual detecting of the impression topography of the generated impression in the workpiece probe. This additional step c2) can increase the accuracy of the present measuring method, as different surface configurations are present over the length and width of continuous workpiece probes in particular. Thus, the continuous workpiece probes can also be measured. In particular, curvatures or deflections over the length or width of the workpiece probe can be eliminated in order to determine the measurement result or the mechanical properties to be determined exactly.

Furthermore, it is conceivable that in step c) an acquisition of a particularly complete impression topography of the generated impression in the workpiece probe takes place. This means that not only parts of the impression topography are measured optically and/or tactilely, but the entire impression topography. This is of particular importance in the case of anisotropic materials. After complete measurement, a geometric division of the impression topography of the generated impression in the workpiece probe can be performed, preferably by determining at least one or more axes of symmetry. By geometrically dividing the impression topography into sections, an increase in the accuracy of the method can be achieved. On the other hand, the computer-based simulation can also be reduced to the corresponding section, which results in a significant gain in time during the method. The above-mentioned sections can preferably have angle pieces with angles of 45°, 90° or 180°, depending on the arrangement of the symmetry axes. It is conceivable that by mirroring or tilting the sections on the basis of the symmetry axes, an averaging and thus an improvement of the measuring accuracy can be achieved. Furthermore, the comparison in step e) can be limited to the corresponding section of the impression topography.

It is also conceivable within the scope of the invention that for each step d) a step c) is performed and subsequently a step e) and/or step d) can be performed. In this case, impression topographies at one and the same location, which have been performed with different test forces or penetration depths, can also be examined in order to improve the measuring accuracy of the method.

In order to accelerate the method, the impression topography detected optically and/or tactilely in step c) can be compared with pre-stored impression topographies from a database, whereby the pre-stored impression topography with the least differences in comparison with step e) can be used to determine the mechanical properties of the workpiece probe. Thus, it may be intended that data from pre-simulated impression topographies are used in step e). Preferably, these data can be stored in a memory and/or database, which are provided in particular in the spaced electronic unit.

Furthermore, it is conceivable that artificial intelligence methods will be used at least for step d) and/or e). On the one hand, this can save time in the method according to the invention and on the other hand, it can also increase the accuracy of the method. However, the use of the artificial intelligence method can significantly increase the effort required in advance for the training of the corresponding control unit. Furthermore, it is conceivable that learning methods, preferably deep learning and/or neural network methods, may be used. Advantageously, these learning methods have been developed to such an extent that they can also be used for difficult and complex application methods, such as those currently available in this method.

It is also possible that in a further step g) correction between the captured impression topography and the simulated impression topography takes place in order to eliminate measurement errors based, for example, on incorrect assumptions in the material model. In addition, the accuracy of the present measuring method can be improved.

Ideally, the method is also used for anisotropic workpiece probes. In particular, direction-dependent properties of the workpiece probe, such as flow limits/strain limits, tensile strength, ductility and/or elongation at break can be determined as a function of the respective direction.

Thus, the method according to the invention can also be applied to rolled, extruded, cast and/or drawn workpiece probes, whereby direction-dependent properties of the material can be measured.

Advantageously, at least one new penetration of the probe, in particular of a probe tip in the workpiece probe, can be performed in step b 2). Preferably, the same predefined test conditions, in particular test force and/or penetration depth, are used. Furthermore, it is conceivable that the position or location of the mechanical impression in the workpiece probe can be determined or selected. Preferably, the measurement can be performed at at least two, preferably three different positions of the workpiece in order to be able to determine the determined mechanical properties of the workpiece probe (i.e. more robust and) more precisely by averaging. Accordingly, the position for a renewed penetration of the probe, in particular the probe tip, into the workpiece probe can be determined fully automatically and/or by an operator. It is conceivable that a new penetration is performed several times at the same (test) point and/or at different points/positions on the workpiece probe. If the test conditions, in particular penetration depth and/or test force, remain the same, changes can be determined when the probe, in particular the probe tip, penetrates the workpiece probe again. In this way, irregularities in the material as well as possible displacements of the probe, especially of a probe tip, can be taken into account when determining the mechanical properties of the workpiece probe. Thus, more homogeneous measurement results can be achieved, which makes a particularly “robust” measurement method possible. It is also conceivable that different material properties are present at different positions on the workpiece probe, so that multiple penetration of the probe, especially of the probe tip at different positions of the workpiece probe, can improve the result of the determination of the mechanical properties. In particular, the measuring method combines a material throw-up and the impression geometry into an impression topography. The impression in the workpiece probe and the simulation model, which is thus measured experimentally, can be used to quantify the height difference of the material throw-up and thus the impression topography.

It is also of particular advantage if a measurement of the measuring method per workpiece probe (time span for one measurement) takes less than 14 seconds, preferably less than 12 seconds and especially preferably less than 8 seconds. The time span for a measurement is defined by the initial step: (i) placing and fixing the workpiece probe in the measuring device, performing the measurement and (ii) completing the determination of the mechanical properties of the workpiece probe (until these are available). Thus, an optimal integration of the measuring device into the production and processing of the workpiece probe is possible (without any delays). In particular, this allows timely feedback for the entire manufacturing and processing method of the workpiece probe.

Within the scope of the invention, a force acting on the probe (test force) and/or a displacement of the probe during penetration and/or retraction can be determined, whereby in particular a load penetration can be determined. The load penetration progression can be used to determine a load penetration curve during the mechanical generation of an impression in the workpiece probe. The load penetration progression or the load penetration curve gives further information about the mechanical properties of the workpiece probe, whereby a measured load penetration progression or a measured load penetration curve can be compared with a simulated load penetration progression or a simulated load penetration curve.

Advantageously, the mechanical properties of the workpiece probe can also be determined as a function of the load penetration curve and a probe tip geometry. The probe tip geometry can be preferably rotationally symmetrical and/or with a conical, spherical and/or sphero-conical and/or globular shape. Depending on the load penetration, especially during penetration and/or retraction of the probe or the probe tip and a probe tip geometry, averaging of the measured data can be performed so that the quality of the test is improved. It is also conceivable that the modulus of elasticity of the material of the workpiece probe is taken into account when determining the mechanical properties of the workpiece probe and/or during the computer-based simulation of a theoretical impression topography. Thus, an improvement or accuracy of the measurement results can be improved by using additional parameters in the form of the modulus of elasticity, so that the algorithm or the heuristic in determining the mechanical properties has at least one further constant available for calculation.

The test load can advantageously be between approximately 10 g and approximately 3,000 kg, preferably between approximately 1,000 g and approximately 1,000 kg, particularly preferably between approximately 10 kg and approximately 500 kg. Furthermore, the depth of the impression can be between about 1 μm and about 3,000 μm (or only 1,000 μm), preferably between about 10 μm and about 500 μm, particularly preferably between about 50 μm and about 250 μm.

Within the scope of the invention, the measurement data and/or the mechanical properties of the workpiece probe can be stored in a database. The database serves for the use of further material tests and can be used as comparison of the already determined material parameters under defined test conditions/parameters. In addition—using the database—measurement results can be interpolated so that improved measurement accuracy can be achieved. The measurement data thus determined, which are stored in a database, can be used for the analysis and optimization of existing products and methods. The smallest deviations from the quality standard can thus be detected early in a production system or in production methods and thus a quicker reaction during production is possible. Thus, a constant quality of the test for the determination of material properties can be provided.

According to another aspect of the invention, a computer program product is claimed for a measuring device for determining mechanical properties of a workpiece probe. In particular, the computer program product according to the invention is configured for a measuring device according to the independent device claim. The computer program product has an algorithm and/or a heuristic which is processed by an electronic unit and/or a control unit, wherein the algorithm and/or the heuristic implements a method according to the independent method claim. Accordingly, the same advantages result for the computer program product according to the invention as have been described in detail with respect to the device according to the invention and the method according to the invention.

Further measures to improve the invention are described in the following description of some embodiments of the invention, which are shown schematically in the figures. All features and/or advantages arising from the claims, the description or the drawings, including constructional details, spatial arrangements and method steps, may be essential to the invention, both individually and in various combinations. It should be noted that the figures are descriptive only and are not intended to limit the invention in any way.

In the following figures, the identical reference signs are used for the same technical characteristics even from different embodiments.

The above explanation of the embodiment describes the present invention exclusively by way of examples. Of course, individual features of the embodiments can be freely combined with each other, if technically reasonable, without leaving the scope of the present invention. Show it:

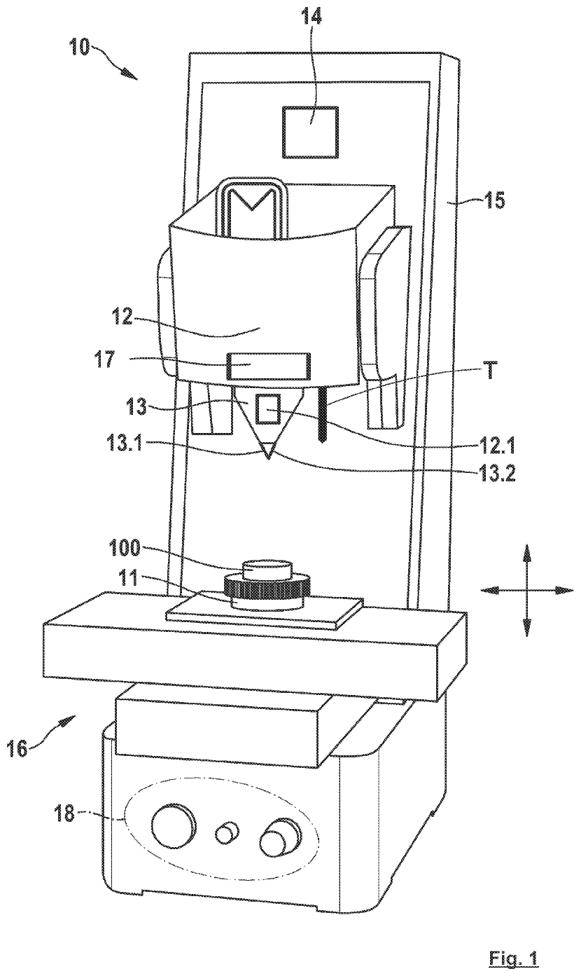

FIG. 1 shows a first embodiment of a measuring device according to the invention,

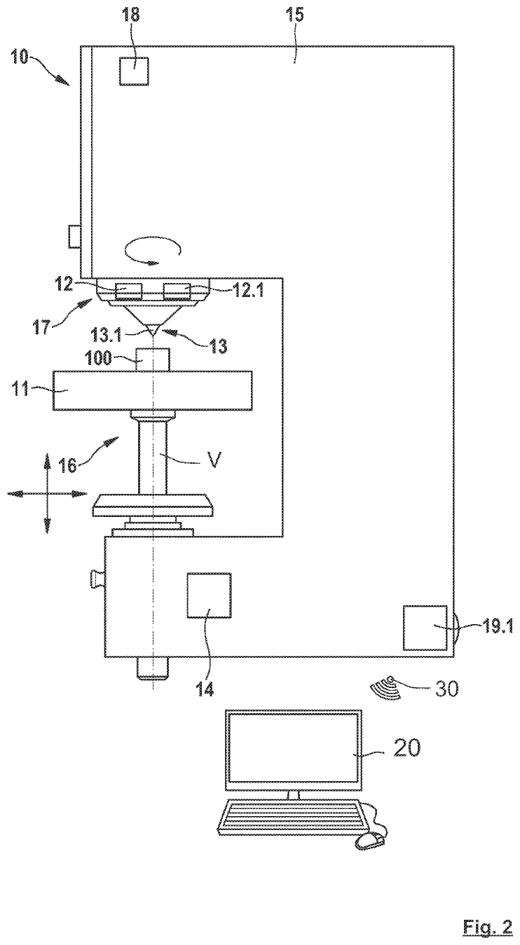

FIG. 2 shows another embodiment of a measuring device according to the invention,

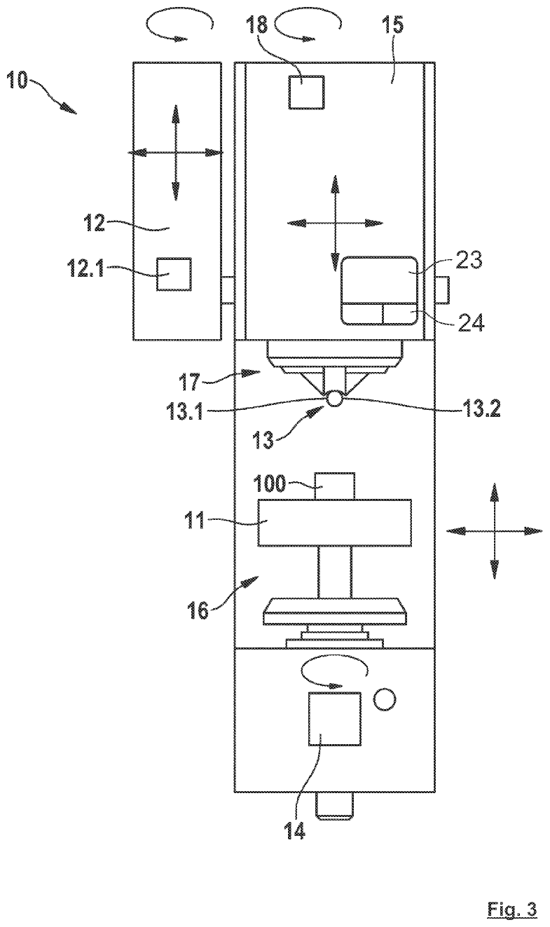

FIG. 3 shows another embodiment of a measuring device according to the invention,

FIG. 4 shows a probe according to the invention and a mechanical impression that can be generated in a workpiece probe,

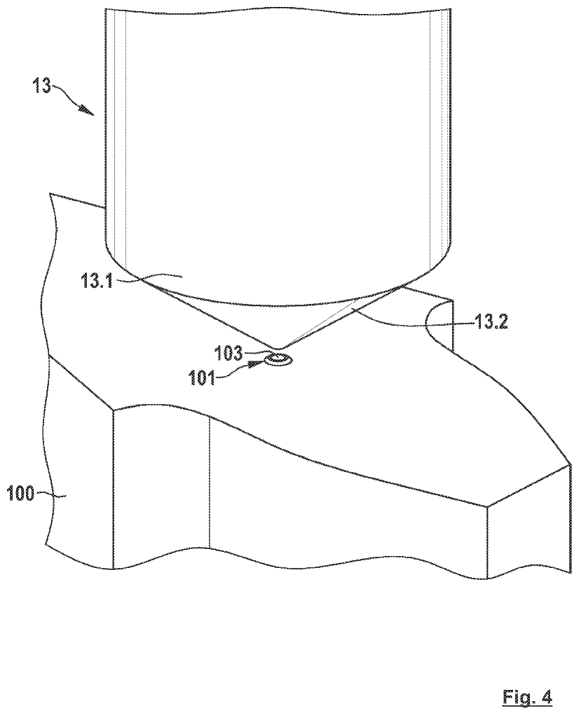

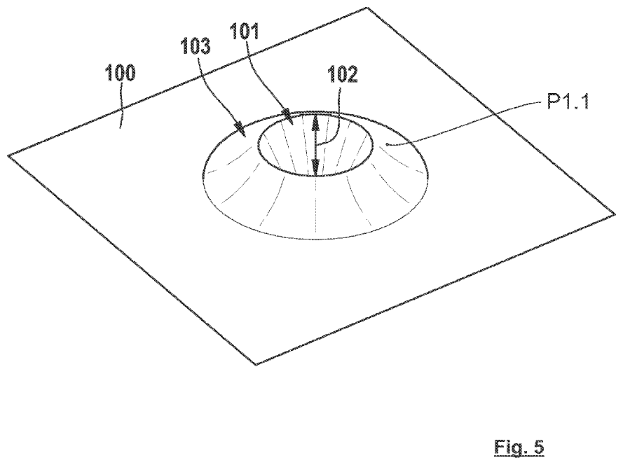

FIG. 5 shows a mechanically generated impression in a workpiece probe,

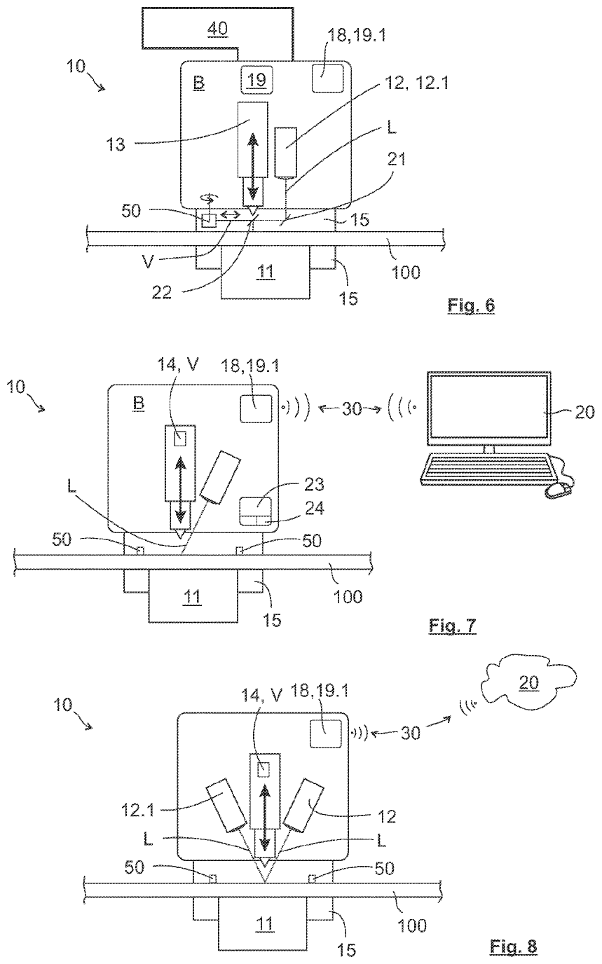

FIG. 6 schematic view of a measuring device according to the invention with a deflector for the beam path of the image acquisition unit,

FIG. 7 schematic view of a measuring device according to the invention with a diagonally arranged image acquisition unit to the mechanical probe,

FIG. 8 schematic view of a comparable measuring device from FIG. 7 with an additional light source to the image acquisition unit,

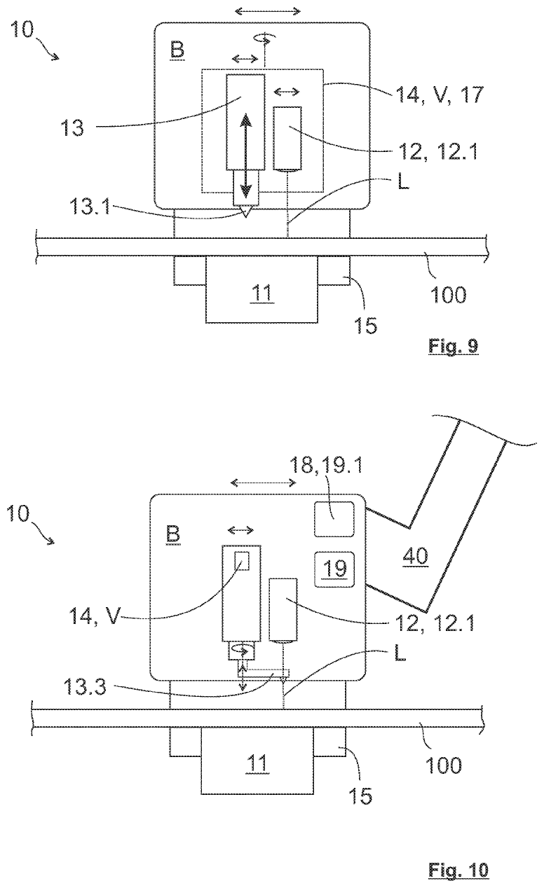

FIG. 9 schematic presentation of a measuring device according to the invention with an adjustable image acquisition unit and an adjustable mechanical probe,

FIG. 10 schematic presentation of a measuring device according to the invention with a mechanical probe and a swiveling test arm for the probe tip,

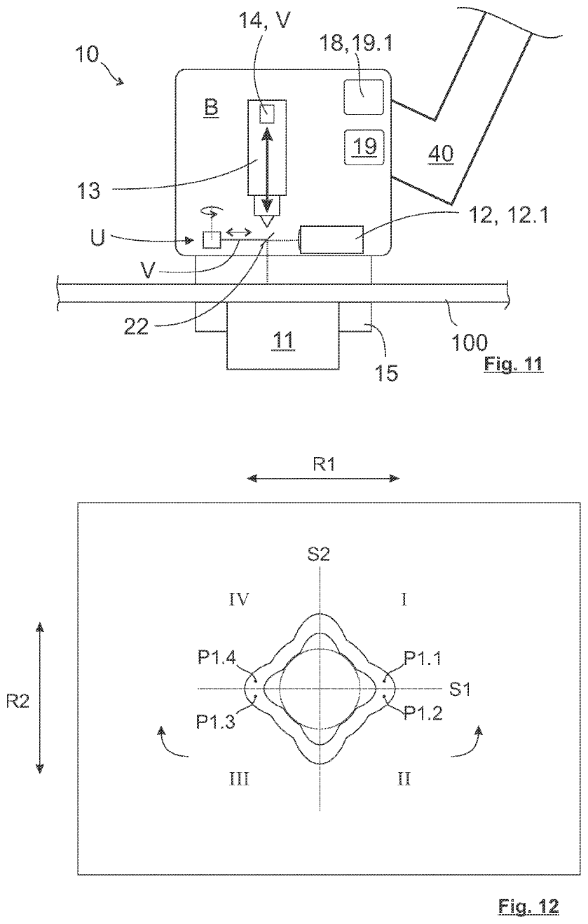

FIG. 11 schematic presentation of a measuring device in accordance with the invention with an image acquisition unit transverse to the mechanical probe,

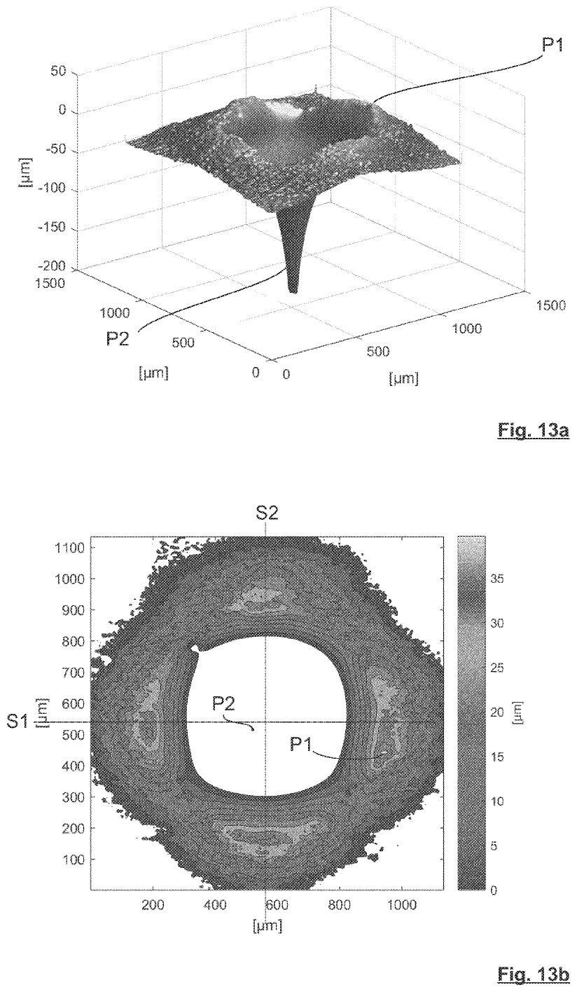

FIG. 12 schematic top view of an actual impression topography in a workpiece probe with anisotropic material properties,

FIG. 13a an exemplary, three-dimensional elevation image of the detected impression topography, e.g. from FIG. 12 and

FIG. 13b conversion of the three-dimensional elevation image from FIG. 13a into a two-dimensional elevation image with additional elevation information.

In the following figures, the identical reference signs are used for the same technical characteristics even from different embodiments.

FIG. 1 shows a measuring device 10 for determining the mechanical properties of a workpiece probe 100 in a first embodiment. The workpiece probe 100 is arranged in a workpiece fixture 11 of the measuring device 10 for testing. In addition, measuring fixture 10 has an image acquisition unit 12 for the optical determination of a workpiece geometry of workpiece probe 100. Optionally or in addition, a depth gauge T can also be provided for tactile determination of a workpiece geometry of the workpiece probe 100. In this case, the image acquisition unit 12 is located in the area of the mechanical probe 13 in or on a test frame 15. The image acquisition unit 12 can be arranged at such a distance from or adjacent to the search unit 13 that optical acquisition of the workpiece probe 100 is possible. It is also conceivable that the image acquisition unit 12 and/or the mechanical probe 13 are arranged so as to be movable in translation and/or rotation on the test frame 15. Accordingly, the mechanical probe 13 and/or the image acquisition unit 12 can be positioned relative to one another or positioned on the test frame 15 in such a way that an impression 101 is generated in the workpiece probe 100 and, following this and/or before an impression 101 is generated in the workpiece probe 100, the image acquisition unit 12 is positioned in such a way that the workpiece geometry and/or the topography of the generated impression 101 can be optically detected. In addition, a drive unit 14 is arranged on the test frame 15 of the measuring device 10, as a result of which it is at least partially possible to position the workpiece receptacle 11, the image acquisition unit 12 and/or the probe 13 relative to one another. The probe 13 as well as the image acquisition unit 12 are arranged on a tool revolver 17, so that by means of the drive unit 14 the probe 13 and/or the image acquisition unit 12 are arranged preferably rotatably on the tool revolver 17. Accordingly, the probe 13 and/or the image acquisition unit 12 can be positioned above the workpiece probe 100 by means of a rotational movement in such a way that either a mechanical impression 101 can be made by the probe 13, in particular by the probe tip 13.1, or the geometry and/or topography of the workpiece probe 100 or the impression 101 can be detected. The probe tip 13.1 is arranged on the probe 13 and has a test probe tip geometry 13.2, the test probe tip geometry 13.2 preferably having a sphero-conical shape which in particular produces a rotationally symmetrical impression 101 in the workpiece probe 100. In FIG. 1, the test frame 15 also has a test table 16 which can be moved horizontally and/or vertically, in particular by the drive unit 14. Accordingly, the drive unit 14 can move the tool revolver 17, in particular the probe 13 with the probe tip 13.1 in the direction of the test table 16 with the workpiece probe 100 arranged in a workpiece receptacle 11 and/or the test table 16 is moved by the drive unit 14 in the direction of the tool revolver 17, so that a mechanical impression 101 in the workpiece probe 100 can be made by the probe 13, in particular the probe tip 13.1. Furthermore, the measuring device 10 has a control unit 18, which is arranged on the test frame 15, whereby a control and/or regulation and/or evaluation of data from the image acquisition unit 12 and the drive unit 14 can be performed via the control unit 18.

FIG. 2 shows a further embodiment of a measuring device 10 according to the invention, with the measuring device 10 having an essentially horizontal U-shaped test frame 15. A control unit 18 for controlling and/or regulating and/or evaluating data from the image acquisition unit 12 and the drive unit 14 is arranged on the test frame 15. In addition, the measuring fixture 10 in FIG. 2 has a tool revolver 17 with an image acquisition unit 12 and light source 12.1 mounted on it. In addition, the tool revolver 17, which is preferably movable in a rotary manner, in particular drivable via the drive unit 14, has a probe 13 with a probe tip 13.1 arranged thereon. The probe tip 13.1 has a conical probe tip geometry 13.2, with which a particularly rotationally symmetrical impression 101 can be generated in the workpiece probe 100. For this purpose, the workpiece probe 100 is fixedly arranged in a workpiece receptacle 11 on a test table 16, the test table 16 being arranged on the test frame 15 so as to be horizontally and/or vertically movable, in particular so as to be drivable via the drive unit 14. In FIG. 2, an interface 19.1 is also arranged on the measuring device 10, whereby data from the image acquisition unit 12 and the drive unit 14 can be transmitted to a spaced electronic unit 19. In FIG. 2, the spaced electronic unit 19 is a computer which is connected to the measuring device 10 via a Bluetooth, WLAN or comparable electromagnetic transmission interface (e.g. RS 232 or USB).

FIG. 3 shows a further embodiment of the measuring device 10 according to the invention, whereby the measuring device 10 has a test frame 15. A control unit 18, a tool revolver 17 and a drive unit 14 are arranged on the test frame 15. Via the drive unit 14, the test table 16 and/or the tool revolver 17 and/or the image acquisition unit 12 can be moved translationally and/or rotationally, in particular horizontally and/or vertically. The image acquisition unit 12 is movably arranged in FIG. 3 on an outer side of the test frame 15, wherein the image acquisition unit 12 is movable on the test frame 15 in such a way that the image acquisition unit 12 can be moved in particular and/or vertically to the test table 16 and/or the tool revolver 17. For this purpose, for example, the image acquisition unit 12 can be arranged on the test frame 15 via a rail and/or a movable arm, so that a movement, in particular a guided movement, can be performed along the rail and/or along a movable arm. The image acquisition unit 12 can be illuminated by means of the light source 12.1 for optical acquisition of the workpiece geometry and/or the impression topography 103, whereby the light source 12.1 can be, for example, an optical sensor, an infrared sensor, an LED and/or an OLED. The tool revolver 17 has a probe 13 with a probe tip 13.1, whereby the probe tip 13.1 is spherical and can generate a mechanical impression 101 in the workpiece probe 100. The workpiece probe 100 is arranged on a workpiece receptacle 11 on a movable test table 16. The test table 16 can be configured to be translatory, in particular horizontally and/or vertically as well as rotatory, and can be driven via the drive unit 14. Accordingly, the drive unit 14 can enable the test table 16 with a workpiece receptacle 11 arranged thereon and the workpiece probe 100 held therein to move in the direction of the tool revolver 17 and thus to the probe 13 and a probe tip 13.1 arranged thereon with a probe tip geometry 13.2.

FIG. 4 shows a probe 13 according to the invention with a sphero-conical probe tip geometry 13.2 of probe tip 13.1. In addition, FIG. 4 shows a workpiece probe 100 with an impression 101, which was generated by the probe tip 13.1 with the probe tip geometry 13.2. The impression 101 shows an impression topography 103, which was generated by the probe tip 13.1 with the probe tip geometry 13.2. The impression topography 103 has an impression depth of 102 and a projection on the circumference of the impression 101. According to the invention, the characteristic impression topography 103, in particular a material throw-up of the impression topography 103, serves to determine the mechanical properties of the workpiece probe 100.

FIG. 5 shows an impression 101 enlarged in a workpiece probe 100. Here, the impression 101 has an impression depth of 102 and a corresponding impression topography of 103. The topography of the impression 103 results from the impression depth 102 and the impression 101 formed by the probe tip as well as a material throw-up formed on the circumference of the impression 101. The impression topography 103 of the impression 101 serves to determine the material parameters of the workpiece probe 100. According to the invention, the impression depth 102 and the throw-up height of the material of the workpiece probe 100 are used to determine the material parameters.

In the further FIGS. 6-11 schematic configurations of the measuring device 10 according to the invention are shown, especially when using continuously formed workpiece probes, especially in the form of rolled material, bar material and the like. These figures deal in particular with the different possible arrangements of the image acquisition unit 12 and the mechanical probe 13 in assembly unit B. Assembly unit B is located above the workpiece probe 100 and accommodates the image acquisition unit 12 and the mechanical probe 13. In addition, a deflection unit U can also be provided for setting and adjusting mirrors 21, 22, which can deflect a beam path L of image acquisition unit 12. In addition to the integrated light source 12.1 in the image acquisition unit 12, an external light source 12.1 can also be used with the measuring device 10 according to the invention.

In FIGS. 6-11 the measuring device 10 can be fed to the workpiece probe 100 via a support arm 40 or a robot arm 40. Ideally, this support arm 40 is attached directly to the test frame 15 in order to achieve high stability. In addition, a fixing unit 50 is optionally available for the measuring fixture 10, which allows it to be fixed to the workpiece probe 100. By means of the fixing unit 50, the workpiece probe can be clamped or clamped between the workpiece fixture 11 in order to safely avoid a relative movement between the measuring device 10 during the measuring method and the workpiece probe 100.

In the following, the differences between the various embodiments of invention-related measuring device 10 are described in FIGS. 6-11.

In FIG. 6, a deflection unit U is provided for deflecting the beam path L, so that the image acquisition unit 12 and the mechanical probe 13 can be arranged rigidly to each other and form the assembly unit B. The first mirror 21 may be fixed to the assembly unit B or the measuring device 10. The second mirror 22, which is movable by the deflector unit U, can be swiveled by a drive unit 14 with an adjustment element V below the probe tip 13.1 to perform the optical measurement. The mirror 22 can be moved longitudinally or by rotation (see arrows). When generating the impression 101, the mirror 22 must be positioned outside the sphere of action of the probe tip 13.1, whereas for the optical detection of the impression topography 103, the second mirror 22 must be positioned below the probe tip 13.1 in order to deflect the beam path L accordingly so that the image acquisition unit 12 can perform an optical detection of the impression topography 103. In FIG. 6, the mechanical probe 13 can be moved vertically together with the probe tip 13.1, or only the probe tip 13.1 can be configured so that it can be withdrawn from the probe 13 by means of an adjusting element V (e.g. cylinder).

In FIG. 7, the image acquisition unit 12 is arranged diagonally to the mechanical probe 13 within assembly unit B. This means that image acquisition unit 12 does not have a direct top view of the generated impression topography, but rather a slight oblique view, which must be compensated for in the further method in order to obtain exact measurement results. Furthermore, FIG. 7 shows a display unit 23 and an input unit 24. The display unit 23 can consist of a display, especially with touch screen function. This display unit 23 can be used, for example, to display error states or measurement results of measuring device 10 and can be influenced by input device 24. FIG. 7 also shows a purely schematic representation of the spaced electronic unit 20 as an external server or computer.

In contrast to FIG. 7, FIG. 8 uses an additional light source 12.1, which is not integrated in the image acquisition unit 12. Both the image acquisition unit 12 and the light source 12.1 are arranged diagonally to the mechanical probe unit 13 on assembly unit B.

In FIG. 9, both the mechanical probe 13 and the image acquisition unit 12 can be moved by the drive unit 14 with a corresponding adjustment element V. A relative movement between the image acquisition unit 12 and the mechanical probe 13 is also conceivable. The movement of the corresponding components can be linear on the one hand or by a rotary and/or pivoting movement on the other. It is also conceivable that the entire assembly unit B is configured to be movable by a linear displacement and/or rotary and/or swiveling movement in order to generate the impression topography 103 on the one hand and to be able to detect it optically and/or tactilely in a plan view on the other hand.

In FIG. 10, the mechanical probe 13 has a test arm 13.3 on which the probe tip 13.1 is located on the underside. This test arm 13.3 can be rotated or swiveled and/or linearly adjustable in order to be able to generate the mechanical impression topography 103 for the workpiece probe 100. As soon as this actual impression topography 103 is generated by the impression 101, the mechanical probe 13 can swivel the test arm 13.3 away above the impression 101 so that the image acquisition unit 12 obtains a top view of the impression topography 103.

In FIG. 11, in contrast to the measuring device 10 from FIG. 6, a deflection unit U is used, which has only one mirror 22 to deflect the beam path L. For this purpose, the image acquisition unit 12 is arranged on assembly unit B at least diagonally or, as in the present case, rotated by 90° to the mechanical probe 13. The mirror 22 can be swiveled or linearly displaced by the deflection unit U, as rotated in FIG. 6, by the adjustment element V.

In the FIGS. 6-11 the different possibilities of movement are arranged in a translatory manner, in the direction of rotation and pivoting by means of corresponding arrows. By means of these movement possibilities, the impression 101 with its actual impression topography 103 can be generated in the workpiece probe 100 and then optical and/or tactile detection can take place. FIGS. 6, 10 and 11 schematically show a support arm 40 or a robot arm 40 for the movable feeding of the measuring device 10 to the workpiece probe 100.

FIG. 12 shows a purely schematic top view of an impression topography 103 for an anisotropic workpiece probe 100. This does not have a rotationally symmetrical configuration, as is indicated in FIG. 5 for isotropic materials. In the present case, the impression topography 103 of impression 101 resembles a cloverleaf in the top view. This impression topography 103 has a total of two axes of symmetry S1 and S2, which allow the sections I-IV to be formed. It should be mentioned at this point that there can also be only one symmetry axis S1 or several symmetry axes. In addition, points P1.1-P1.4 are indicated, which have the same height information of the impression topography 103 and come to lie on top of each other by folding or mirroring in sections. This is indicated by the folding arrows in FIG. 12 in sections II and III, which can be used to generate a folding up of sections II and III on the basis of the axis of symmetry S1 to sections I and IV.

In FIGS. 13a and 13b, the measurement data obtained in step c) are arranged in a three-dimensional coordinate system. The impression 101 was introduced into a workpiece probe 100 made of an aluminum alloy. This shows that height information is stored for each two-dimensional point P, resulting in the three-dimensional model of the impression topography in FIG. 13a with points P1 and P2. The corresponding two-dimensional model with points P1 and P2 is shown in FIG. 13b, whereby the individual points have height information in addition to their x and y coordinates, in order to be able to mathematically represent the three-dimensional impression topography. This height information is expressed in FIGS. 13a and 13b by the different shades of grey.

The above explanation of the embodiments describes the present invention exclusively within the scope of examples. Of course, individual features of the present invention can be freely combined with each other, if technically reasonable, without leaving the scope of the present invention/claims.

### LIST OF REFERENCE SIGNS

10 Measuring device
11 Workpiece receptacle
12 Image acquisition unit
12.1 Light source
13 Probe
13.1 Probe tip
13.2 Probe tip geometry
13.3 Test arm
14 Drive unit
15 Test frame
16 Test table
17 Tool revolver
18 Control unit
19 Electronic unit
19.1 Interface to 19
20 Spaced electronics unit, such as external server and/or cloud
21 Mirror, especially fixed
22 Mirror, especially adjustable by U
22 Display unit, display
23 Input unit, keys/touch screen
24 Data link, wireless or wired
40 Robot or support arm
50 Fixing unit
100 Workpiece probe
101 Impression
102 Impression depth
103 Impression topography
B Assembly unit
V Adjusting element
U Deflection unit
L Beam path
S1, S2 Symmetry axes from 103
T Depth gauge
I-IV Parts from 103
R1, R2 Directions
Px.y Points, in particular measuring points of 103 in the sections

1-25. (canceled)

26. A measuring device for determining at least one mechanical property of a workpiece probe, comprising
at least one image acquisition unit for optically determining a workpiece geometry of the workpiece probe, and
at least one mechanical probe for generating an impression in the workpiece probe,
wherein,
at least the image acquisition unit and the mechanical probe together form a structural unit.

27. The measuring device according to claim 26,
wherein,
a workpiece receptacle is provided for fixing and testing the workpiece probe.

28. The measuring device according to claim 26,
wherein,
at least one drive unit is provided for at least partially positioning at least the workpiece receptacle,
the image acquisition unit or the probe relative to one another.

29. The measuring device according to claim 26,
wherein,
the assembly unit comprises at least one adjusting element, as a result of which at least the image acquisition unit and the probe are arranged so as to be movable relative to one another,
wherein in particular the adjusting element only moves the image acquisition unit or the probe.

30. The measuring device according to claim 26,
wherein,
at least one adjusting element of the assembly unit can be moved by a drive unit,
wherein in particular at least two adjusting elements can be driven by a drive unit.

31. The measuring device according to claim 26,
wherein,
the assembly unit comprises at least one deflection unit, whereby a beam path of the image acquisition unit can be deflected,
wherein in particular an adjusting element is provided for adjusting at least one mirror.

32. The measuring device according to claim 26,
wherein,
at least the image acquisition unit, the probe, the drive unit and the workpiece receptacle are arranged on a test frame.

33. The measuring device according to claim 26,
wherein,
the probe has a probe tip.

34. The measuring device according to claim 26,
wherein,
at least one depth gauge is provided for the probe,
whereby preferably at least one impression depth of the probe in the workpiece probe can be measured.

35. The measuring device according to claim 26,
wherein,
a light source is provided,
wherein in particular the unit comprises the light source.

36. The measuring device according to claim 26,
wherein,
at least the measuring device can be arranged or moved on a supporting arm,
or at least that the measuring device forms a feedback in a control loop of a manufacturing or processing method of the workpiece probes, preferably in that the measuring device transmits the respective specific mechanical properties of a workpiece probe to a spaced-apart electronic unit.

37. The measuring device according to claim 26,
wherein,
the workpiece probe comprises a metal or its alloys,
preferably contains at least aluminum, magnesium, lead, iron, steel, stainless steel, gold, molybdenum, nickel, copper, silver, vanadium, tungsten, zinc, tin, titanium or an alloy such as brass.

38. The measuring device according to claim 26,
wherein,
at least one control unit is provided for at least controlling or regulating or evaluating data of the image acquisition unit and the drive unit or the drive unit to a spaced-apart electronics unit, in particular at least external server or cloud,
wherein the interface implements a wireless data transmission, in particular via at least WLAN or Bluetooth data technology, or a cable-bound data transmission, in particular via USB data technology.

39. A method for determining at least one mechanical property of a workpiece probe comprising at least one of the following steps or all of the following steps:
a) At least optical or tactile detection of a workpiece geometry of the workpiece probe,
b) Generating an impression by penetration of a probe,
c) At least optical or tactile detection of an impression topography of the generated impression in the workpiece probe,
d) In particular computer-based simulation of a theoretical impression topography using a material model, in particular an elastoplastic material model, preferably for anisotropic materials,
e) Comparison of the simulated and the generated impression topography,
f) Determination of the mechanical properties of the workpiece probe as a function of steps a) to e).

40. The method according to claim 39,
wherein,
in a step b2) at least one renewed penetration of the probe, into the workpiece probe is performed,
wherein step c) in particular follows in order to perform the detection of the respective impression topography of the generated impression in the workpiece probe.

41. The method according to claim 39,
wherein,
a step c2) the detected workpiece geometry of the workpiece probe from step a) is taken into account in the actual detection of the impression topography of the generated impression in the workpiece probe.

42. The method according to claim 39,
wherein,
in step c) an acquisition of an impression topography of the generated impression in the workpiece probe takes place,
in which in particular subsequently a geometrical division of the impression topography of the impression generated in the workpiece probe is performed, preferably by determining at least one axis of symmetry.

43. The method according to claim 39,
wherein,
before or in step d), a determination of sections, of the impression topography of the generated impression in the workpiece probe, preferably on the basis of the determined axis of symmetry is performed.

44. The method according to claim 39,
wherein,
step d) at least one FEM simulation of a theoretical impression topography is performed using the material model.

45. The method according to claim 39,
wherein,
for each step d) performed, a step c) is performed, followed by at least a step e) or step d).

46. The method according to claim 39,
wherein,
step e) data from pre-simulated impression topographies are used,
whereby preferably these data are stored in at least a memory or a database.

47. The method according to claim 39,
wherein,
at least for step d) or e) artificial intelligence methods are used,
which in a further step g) a correction takes place between the captured impression topographies and the simulated impression topographies.

48. The method according to claim 39,
wherein,
an application of the method is also used for anisotropic workpiece probes,
wherein, such as, for example, at least yield strength/strain limit, tensile strength, ductility or elongation at fracture, can be determined.

49. The method according to claim 39,
wherein,
at least the case of rolled, extruded, cast or drawn workpiece probes, direction-dependent properties of the material can be measured, or
that one measurement of the measuring method per workpiece probe takes less than 14 seconds, preferably less than 12 seconds.

50. A computer program product for a measuring device for determining mechanical properties of a workpiece probe, wherein,
the program has at least an algorithm or a heuristic which is processed by an electronic unit, wherein in particular at least the algorithm or the heuristic implements the method for determining at least one mechanical property of a workpiece probe comprising at least one of the following steps or all of the following steps:
a) At least optical and/or tactile detection of a workpiece geometry of the workpiece probe,
b) Generating an impression by penetration of a probe into the workpiece probe with defined test conditions,
c) At least optical and/or tactile detection of an impression topography of the generated impression in the workpiece probe,
d) In particular computer-based simulation of a theoretical impression topography using a material model, in particular an elastoplastic material model, preferably for anisotropic materials,
e) Comparison of the simulated and the generated impression topography,
f) Determination of the mechanical properties of the workpiece probe as a function of steps a) to e).
